(19) United States
(12) Patent Application Publication
(10) Pub. No.: US 2007/0220145 A1
(43) Pub. Date: Sep. 20, 2007

(54) Computer product, access-restricting method, and proxy server

(75) Inventors: Fumihiko Kozakura, Kawasaki (JP); Fumihito Nishino, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/480,540

(22) Filed: Jul. 5, 2006

(30) Foreign Application Priority Data
Mar. 16, 2006 (JP) 2006-072903

(51) Int. Cl. G06F 15/173

(52) U.S. Cl. 709/225; 709/223

(57) ABSTRACT

A proxy server stores therein an access prohibiting list; analyzes contents requested by a user; extracts link information included in the contents; checks whether the link information includes an access-prohibited URL included in the access prohibiting list; deletes the link information if it includes the access-prohibited URL; and sends the remaining contents to a client computer.

### BACKGROUND OF THE INVENTION

1. Field of the Invention

The present invention generally relates to a technology for accessing contents, and more specifically relates to display of access prohibited contents.

2. Description of the Related Art

The development of network technologies has made it possible to publish huge amount of information. Such information is placed on servers and/or computers that are distributed all over the world and that are connected to each other via networks such as the Internet and/or intranet.

Generally, the information is available to anybody. Some information is, however, relevant to certain situations while other information is not relevant to those situations. For, example, for an employee of a law firm, information on stock rate is not relevant information during working hours. There has been a trend in institutions, such as schools, universities, and companies, toward restricting access to irrelevant information. This is generally achieved by employing a proxy server. The proxy server is put between an internal network of the institution and the Internet. The internal network typically includes many client terminals. The proxy server decides whether to allow or restrict access by the client terminals to contents available over the Internet.

A typical proxy server stores therein addresses of one or more restricted websites. When the proxy server receives an access request from a client terminal, it checks whether the access request corresponds to an address of the restricted websites. If the access request corresponds to the address of the restricted websites, the proxy server rejects the access request and causes the client terminal to display a message that says that access is restricted. A proxy server disclosed in Japanese Patent Publication No. 2002-182969 rejects access requests from the client terminal based on not only access-restricted addresses but also based on the contents that the access request is trying to access.

However, conventionally, the user of the client terminal cannot know whether the contents he is trying to access are access-restricted contents unless he accesses those contents. Assume that a user perform search using a search engine and that there are many hits. In that case, the user cannot know if a certain link is access-restricted unless he accesses the link.

Thus, there is a need of a technology that makes it possible to know whether certain contents are restricted before accessing the contents.

### SUMMARY OF THE INVENTION

It is an object of the present invention to at least partially solve the problems in the conventional technology.

According to an aspect of the present invention, a method executed by a proxy server to control access from a client computer to contents in a contents server includes receiving an access request from the client computer indicative of permission to access first contents in the contents server and sending received access request to the contents server; analyzing the first contents received from the content server in response to the access request; extracting link information included in the first contents that is linked to second contents; checking whether access to the second contents has been prohibited based on access-prohibiting information; deleting the link information of the second contents from the first contents if it is determined at the checking that access has been prohibited to the second contents thereby obtaining third contents; and sending the third contents to the client computer.

According to another aspect of the present invention, a proxy server that controls access from a client computer to contents in a contents server includes a storage unit that stores therein access-prohibiting information; a communication unit that receives an access request from the client computer indicative of permission to access first contents in the contents server and sends received access request to the contents server; a contents extracting unit that analyzes the first contents received from the content server in response to the access request, and extracts link information included in the first contents that is linked to second contents; an access checking unit that checks whether access to the second contents has been prohibited based on the access-prohibiting information; and a contents deleting unit that deletes the link information of the second contents from the first contents if it is determined at the checking that access has been prohibited to the second contents thereby obtaining third contents. The communication unit sends the third contents to the client computer.

According to another aspect of the present invention, a computer-readable recording medium stores therein a computer program that enables a proxy server to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining the concept of access restriction according to a first embodiment of the present invention;

FIG. 2 is a detailed functional block diagram of a proxy server shown in FIG. 1;

FIG. 3 is an example of the contents of an access prohibiting list shown in FIG. 2;

FIG. 4 is a schematic for explaining how a contents editor deletes link information;

FIG. 5 is a schematic for explaining how the contents editor deletes paragraph information;

FIG. 6 is a flowchart of a process performed by the proxy server shown in FIG. 2;

FIG. 7 is a schematic for explaining the concept of access restriction according to a second embodiment of the present invention;

FIG. 8 is a detailed functional block diagram of a proxy server shown in FIG. 7;

FIG. 9 is an example of the contents of an access prohibiting list shown in FIG. 8;

FIG. 10 is a schematic for explaining the concept of access restriction according to a third embodiment of the present invention;

FIG. 11 is a detailed functional block diagram of a proxy server shown in FIG. 10;

FIG. 12 is an example of the contents of an access prohibiting list shown in FIG. 11; and

FIG. 13 is a functional block diagram of a computer that implements the methods according to any one of the first, the second, and the third embodiments.

### DETAILED DESCRIPTION OF THE PREFERRED EMBODIMENTS

Exemplary embodiments of the present invention are explained below in detail referring to the accompanying drawings. The present invention is not limited to the embodiments explained below.

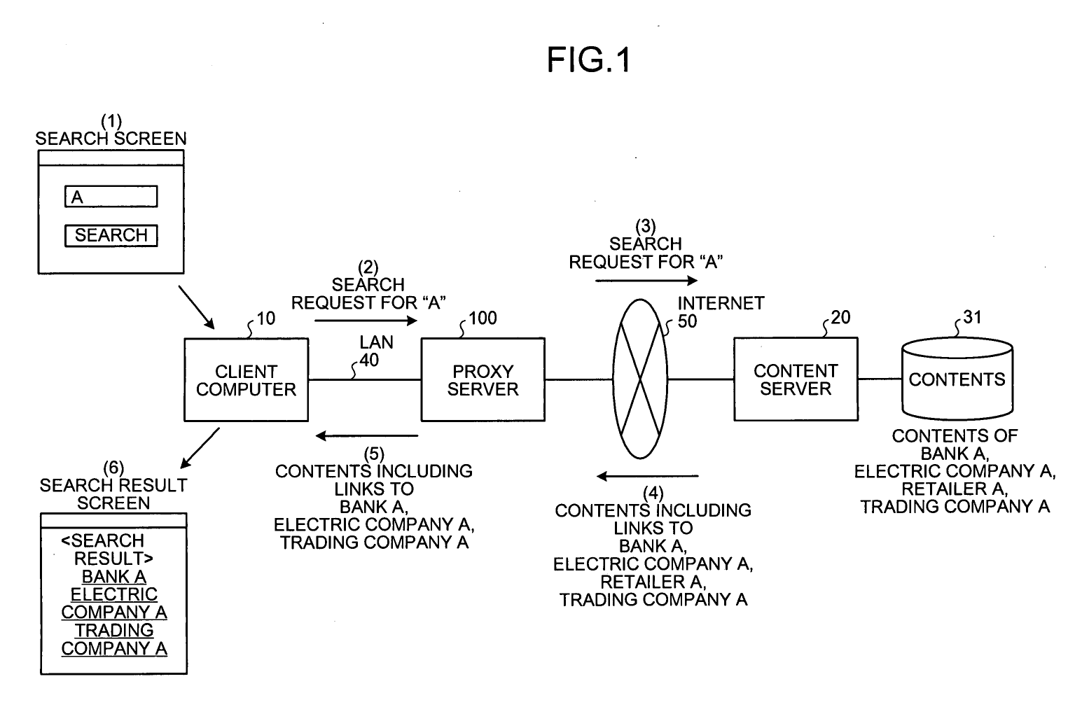

FIG. 1 is a schematic for explaining the concept of access restriction according to a first embodiment of the present invention. A proxy server 100 is connected to client computers 10 used by employees of a company via an internal local area network (LAN) 40, and connected to a web server (hereinafter, “content server”) 20 that manages various contents 31 via the Internet 50.

The proxy server 100 stores therein an access prohibiting list. The list includes uniform resource locators (URLs) that locate prohibited contents (hereinafter, “access-prohibited URLs”). The employees are prohibited from accessing the access-prohibited contents. The proxy server 100 restricts access to the employees to the contents based on the access-prohibited URLs on the access prohibiting list.

The client computer 10 used by each of the employees includes a browser for displaying the contents. The employee can browse various contents using the browser by acquiring the contents through the proxy server 100.

While a single client computer 10 and a single content server 20 are used in the explanation below just for convenience, the proxy server 100 can be actually connected to a plurality of the client computers 10 via the LAN 40 and connected to a plurality of the content servers 20 via the Internet 50.

In such an environment, each of the employees can collect information by browsing various contents via the Internet 50 to research the trends of competitive companies and markets.

It is assumed here that an employee searches the Internet using “A”, for example, as a keyword (see (1) in FIG. 1). A request for search that specifies the content server of the provider of the search engine (herein, content server 20) as the destination is sent from the client computer 10 to the proxy server 100 (see (2) in FIG. 1). Upon receiving the search request, the proxy server 100 sends the search request to the content server 20 (see (3) in FIG. 1).

The content server 20 regularly searches other content servers (not shown) and acquires, for example, URLs including information related to A from the contents information stored in database. The content server 20 then produces the contents of search result including the URLs, and sends the search-result contents to the proxy server 100.

For example, the content server 20 produces the search-result contents including URLs that locate contents of a bank A, an electric company A, a retailer A, and a trading company A, and sends the search-result contents to the proxy server 100 (see (4) in FIG. 1).

Upon receiving the search-result contents, the proxy server 100 analyzes hypertext markup language (HTML) information that defines the search-result contents, and extracts the URLs (hereinafter, “link URL”) included in the search-result contents. The proxy server 100 then determines whether there is an URL equivalent to any access-prohibited URL registered to the access prohibiting list among the extracted link URLs.

It is assumed here that the access prohibiting list includes a link URL equivalent to the website of the retailer A.

The proxy server 100 deletes the link URL to the contents of the retailer A from the search-result contents, and sends the remaining search-result contents to the client computer 10 (see (5) in FIG. 1).

The client computer 10 displays the link information including only the link URLs to the contents of the bank A, the electric company A, and the trading company A via the browser based on the received search-result contents (see (6) in FIG. 1).

In this manner, the proxy server 100 provides only the permitted link URLs to the users. As a result, the user can efficiently collect information without wasting time by trying to access prohibited websites.

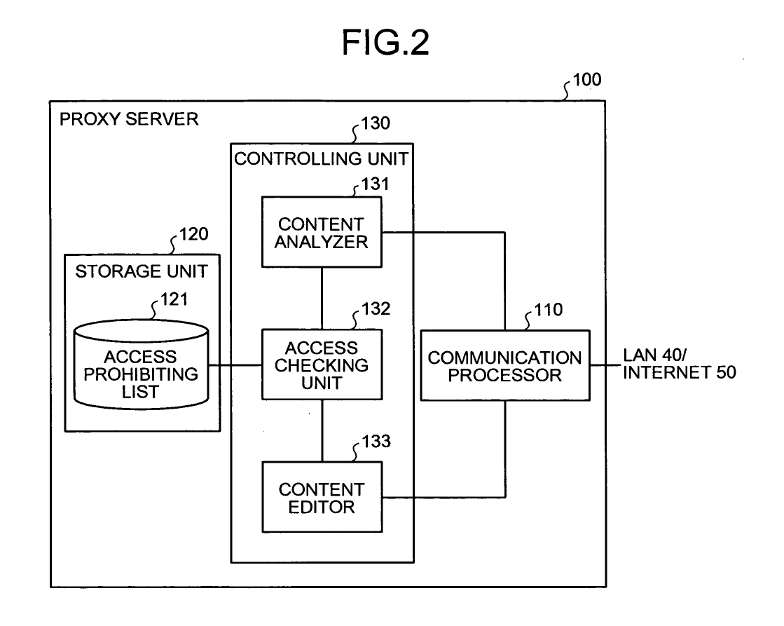

FIG. 2 is a detailed functional block diagram of the proxy server 100. The proxy server 100 includes a communication processor 110, a storage unit 120, and a controlling unit 130.

The communication processor 110 controls exchange of information between the client computer 10 and the content server 20. For example, the communication processor 110 receives a request for access to certain contents from the client computer 10 and sends the request to the content server 20, and receives the requested contents from the content server 20 and sends the contents to the client computer 10.

The storage unit 120 stores therein data and computer programs required for processes performed by the controlling unit 130. The storage unit 120 stores therein an access prohibiting list 121.

The access prohibiting list 121 includes access-prohibiting information used to determine whether access to certain contents is to be prohibited. More specifically, the access prohibiting list 121 includes access-prohibited URLs specified by, for example, a network administrator in the company.

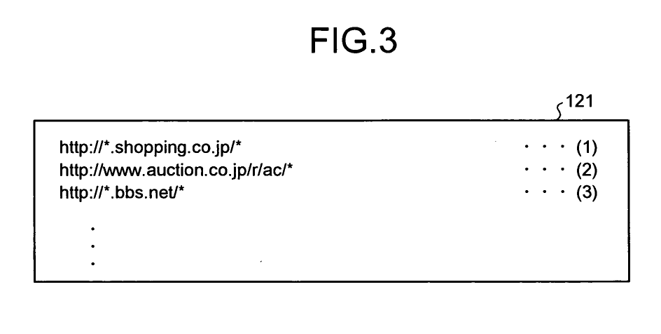

FIG. 3 is an example of the contents of the access prohibiting list 121. The access prohibiting list 121 includes, for example, URLs that locate shopping sites (see (1) in FIG. 3), auction sites (see (2) in FIG. 3), and bulletin boards (see (3) in FIG. 3), each including an asterisk at some position. The asterisk is a wildcard character that accepts any letters.

Because the access prohibiting list 121 stores the access-prohibited URLs to which users are not permitted to access, the proxy server 100 can restrict access to the predetermined access-prohibited contents.

The controlling unit 130 includes a memory to store therein a control program such as an operating system (OS), other computer programs that define various procedures, and required data, and performs the procedures. As shown in FIG. 2, the controlling unit 130 includes a content analyzer 131, an access checking unit 132, and a content editor 133.

The content analyzer 131 analyzes contents acquired from the content server 20 based on the access request that the employee sent from the client computer 10, and extracts link information that includes link URLs.

More specifically, upon receiving the contents from the content server based on the access request, the content analyzer 131 analyzes HTML information that defines the contents; finds a link URL included in the HTML information; and extracts the link information that includes the URL or paragraph information that includes the link information.

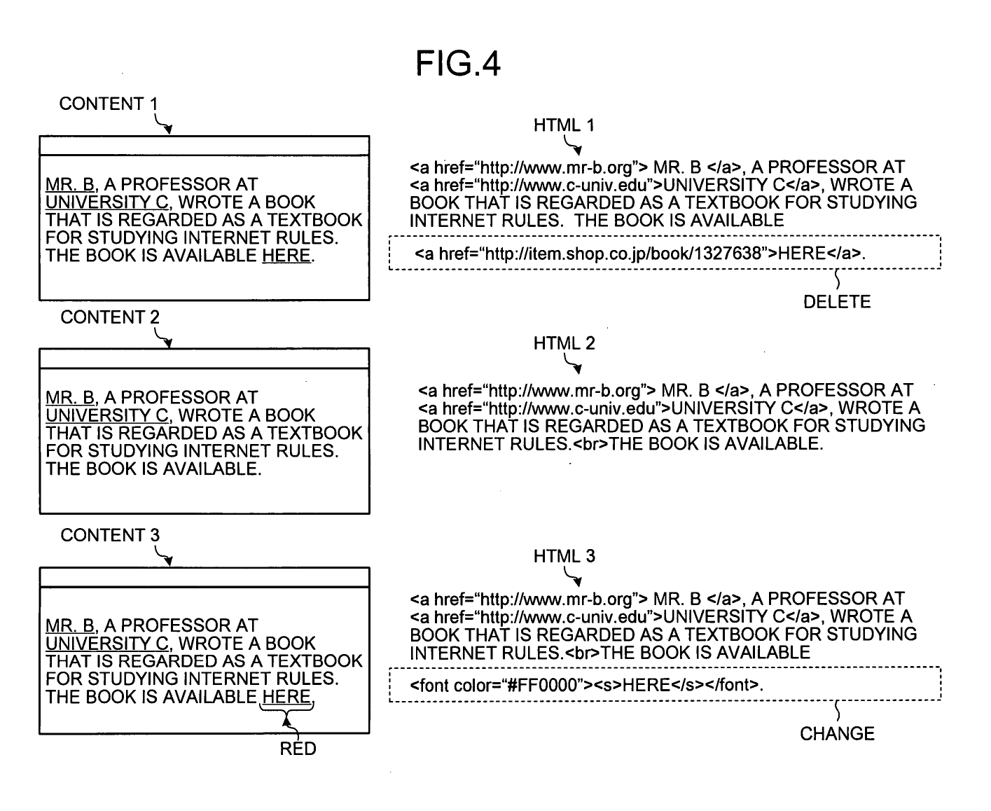

The link information in FIG. 4 refers to a piece of information described between tags <a and </a in the HTML information including the tags <a and </a. For example, the link information can be described as <a href=“http://item.shop.co.jp/book/1327638”>HERE</a>. The link information includes a link URL http://item.shop.co.jp/book/1327638.

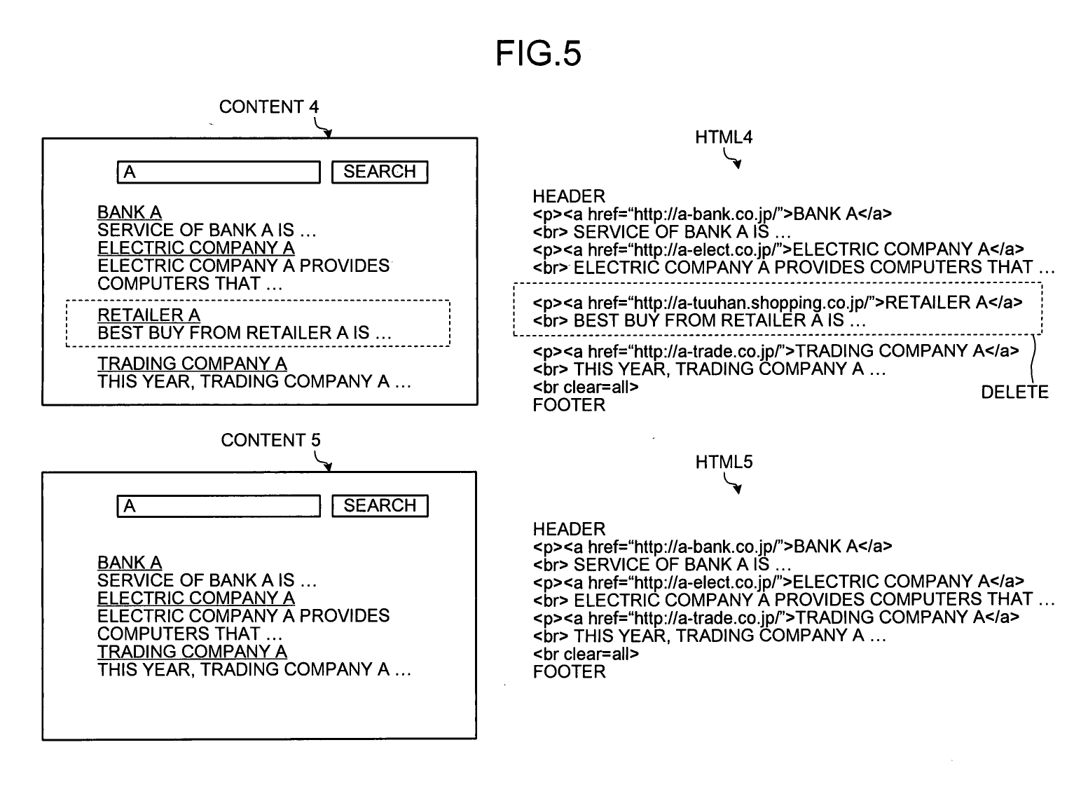

The paragraph information in FIG. 5 refers to a piece of information between a preceding tag <p and a following tag <p in the HTML information including the preceding tag <p and excluding the following tag <p. For example, the paragraph information is described as <p><a href=“http://a-tuuhan.shopping co.jp/”>RETAILER A</a> <br>BEST BUY FROM RETAILER A IS . . . . The paragraph information includes link information <a href=“http://a-tuuhan.shopping co.jp/”>RETAILER A</a>. The last paragraph information in the HTML information is configured to indicate the end position of the paragraph information by a predetermined tag such as <br clear=all for initializing the definition or a tag that indicates the footer of the contents.

The content analyzer 131 extracts the link information in either unit of the link information or the paragraph information. It is determined in which unit the link information is extracted based on the URL specified based on the access request and a process-unit determination list (not shown) registered to the storage unit 120.

The process-unit determination list stores therein URLs each including a wildcard character in association with either unit of the link information or the paragraph information. The content analyzer 131 determines which unit should be used to extract the link information by checking the process-unit determination list for the URL specified by the access request.

The access checking unit 132 checks whether access to the contents of the URL included in the extracted link information is prohibited based on the access-prohibiting information in the access prohibiting list 121. More specifically, the access checking unit 132 searches the access prohibiting list 121 for an URL equivalent to one of the URLs included in the link information extracted by the content analyzer 131. When an equivalent URL is found, the access checking unit 132 transfers the link information that includes the link URL to the content editor 133 as access-prohibited link information.

While the explanation is made herein assuming that the access checking unit 132 checks whether the access to the contents is prohibited based on the access-prohibited URLs in the access prohibiting list 121, the access prohibiting list 121 can store therein keywords (character strings) to be included in the prohibited contents as access-prohibited keywords. In this manner, the access checking unit 132 checks whether the contents include any of the access-prohibited keywords to determine whether access to the contents is prohibited.

As a result, access can be restricted by the predetermined access-prohibited keywords even when the URL of the prohibited contents changes frequently.

The content editor 133 deletes the access-prohibited link information transferred from the access checking unit 132 from the contents acquired from the content server 20, and sends the remaining contents to the client computer 10. More specifically, the content editor 133 deletes the access-prohibited link information from the HTML information that defines the contents, and sends the contents defined by the remaining HTML information to the client computer 10.

FIG. 4 is for explaining how the content editor 133 deletes link information. It is assumed here that, for example, the contents defined by an HTML 1 have been sent from the content server 20, and that the access checking unit 132 has transferred the link information <a href=“http://item.shop.co.jp/book/1327638”>HERE</a> to the content editor 133 as the access-prohibited link information.

The content editor 133 then deletes the access-prohibited link information (indicated by “DELETE” in FIG. 4) from the HTML 1 and sends the contents defined by the remaining HTML information to the client computer 10. The HTML 2 in FIG. 4 is the HTML information after the deletion of the access-prohibited link information. Contents 1 and Contents 2 are respectively defined by the HTML 1 and the HTML 2 and displayed by the browser installed in the client computer 10.

FIG. 5 is for explaining how the content editor 133 deletes the paragraph information. It is assumed that, for example, the contents defined by the HTML 2 has been sent from the content server 20, and that the access checking unit 132 has transferred the paragraph information <p><a href=“http://a-tuuhan.shopping co.jp/”>RETAILER A</a> <br>BEST BUY FROM RETAILER A IS . . . to the content editor 133 as the access-prohibited link information.

The content editor 133 then deletes the access-prohibited link information (indicated by “DELETE” in FIG. 5) from the HTML 3 and sends the contents defined by the remaining HTML information to the client computer 10. The HTML 2 in FIG. 5 is the HTML information after the deletion of the access-prohibited link information. Contents 4 and contents 5 are defined by an HTML 4 and an HTML 5 respectively and displayed by the browser installed in the client computer 10.

While a case has been explained above in which the content editor 133 deletes the link information for the access-prohibited contents, any other method can be employed. For example, it is possible to change the format of text information such as the font, the color, and the presence of the underline, to indicate the deletion of the link information. In this example, the text information including the link information or the paragraph information is not deleted, like the text “HERE” shown in the contents 3 in FIG. 4.

In other words, like the HTML 3 shown in FIG. 4, <a href=“http://item.shop.co.jp/book/1327638”>HERE</a> is replaced with <font color=“#FF0000”><s>HERE</s></font> (indicated by “CHANGE” in FIG. 4). As a result, the color of the text “HERE” is changed to red because it is caught between the tags <font color=“#FF0000”>and </font>, and the text is also underlined because it is caught between the tags <s> and </s>.

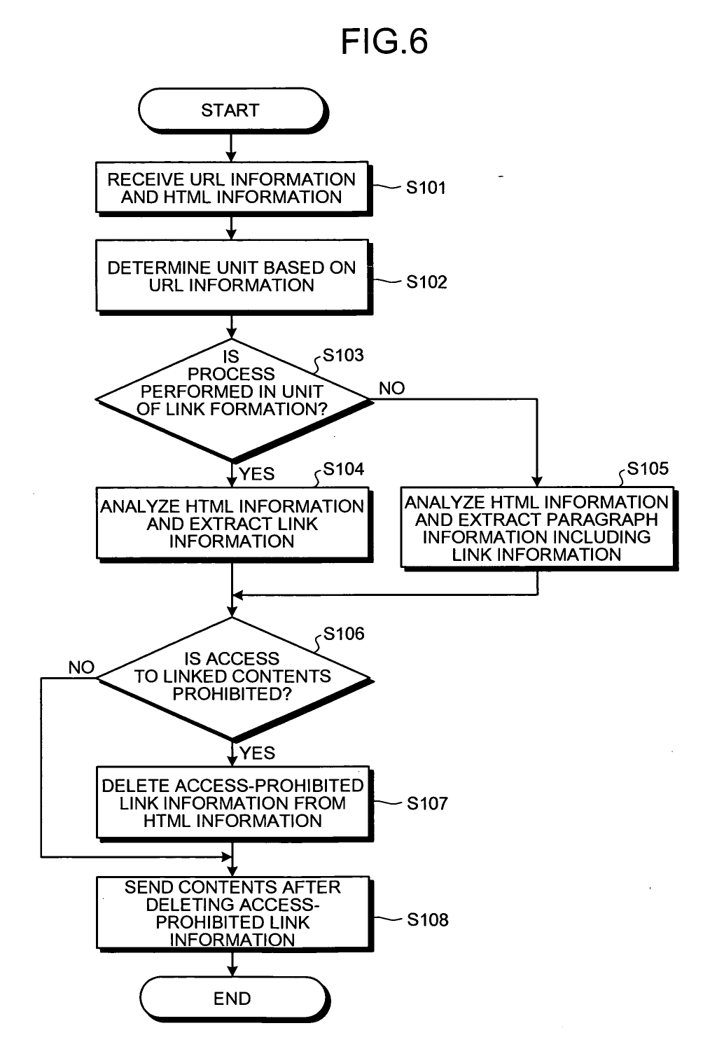

FIG. 6 is a flowchart of a process performed by the proxy server 100. When the proxy server 100 receives the contents from the content server 20 (step S101), the content analyzer 131 determines the information unit based on the URL specified by the access request (step S102).

When the process is performed in the unit of link information (YES at step S103), the content analyzer 131 analyzes the HTML information that defines the contents and extracts the link information from the HTML information (step S104). On the other hand, when the process is performed in the unit of paragraph information (NO at step S103), the content analyzer 131 analyzes the HTML information that defines the contents and extracts the paragraph information that includes the link information from the HTML information (step S105).

The access checking unit 132 checks whether the access prohibiting list 121 includes a URL equivalent to any of the link URLs in the link information or the paragraph information extracted by the content analyzer 131 and determines whether access to the contents indicated by the link URL is prohibited (step S106). If access to the contents is prohibited (YES at step S106), the access checking unit 132 transfers the information including the link URL to the content editor 133 as the access-prohibited link information.

The content editor 133 then deletes the access-prohibited link information from the HTML information that defines the contents (step S107), and sends the contents defined by the remaining HTML information after the deletion to the client computer 10 (step S108).

As described above, according to the first embodiment, the access prohibiting list 121 stores therein the list of URLs indicative of prohibited contents; the content analyzer 131 analyzes the contents received from the content server 20 and extracts link information for other contents included in the contents; the access checking unit 132 checks whether access to the contents located by the URL included in the extracted link information is prohibited based on the access prohibiting list 121; and the content editor 133 deletes the link information that includes the link URL indicative of the prohibited contents from the received contents and sends the remaining contents to the client computer 10. This configuration enables the proxy server 100 to provide only the link URLs indicative of contents that are permitted for the user to access, and therefore the user can efficiently collect information without wasting time by trying to access prohibited websites.

While the access is restricted based on the access-prohibited URLs according to the first embodiment, the access restriction can be performed based on a condition unique to each user, or some of the prohibited contents can be permitted as exceptions.

According to a second embodiment, the access restriction is performed based on the information on access-prohibited users who are prohibited to access predetermined contents and access-permitted URLs indicative of some of the access-prohibited URLs that are exceptionally permitted to access, in addition to the access-prohibited URLs. The second embodiment is explained assuming that each of the proxy servers is connected to a client computer via the LAN in a school and to a content server via an external wide area network (WAN).

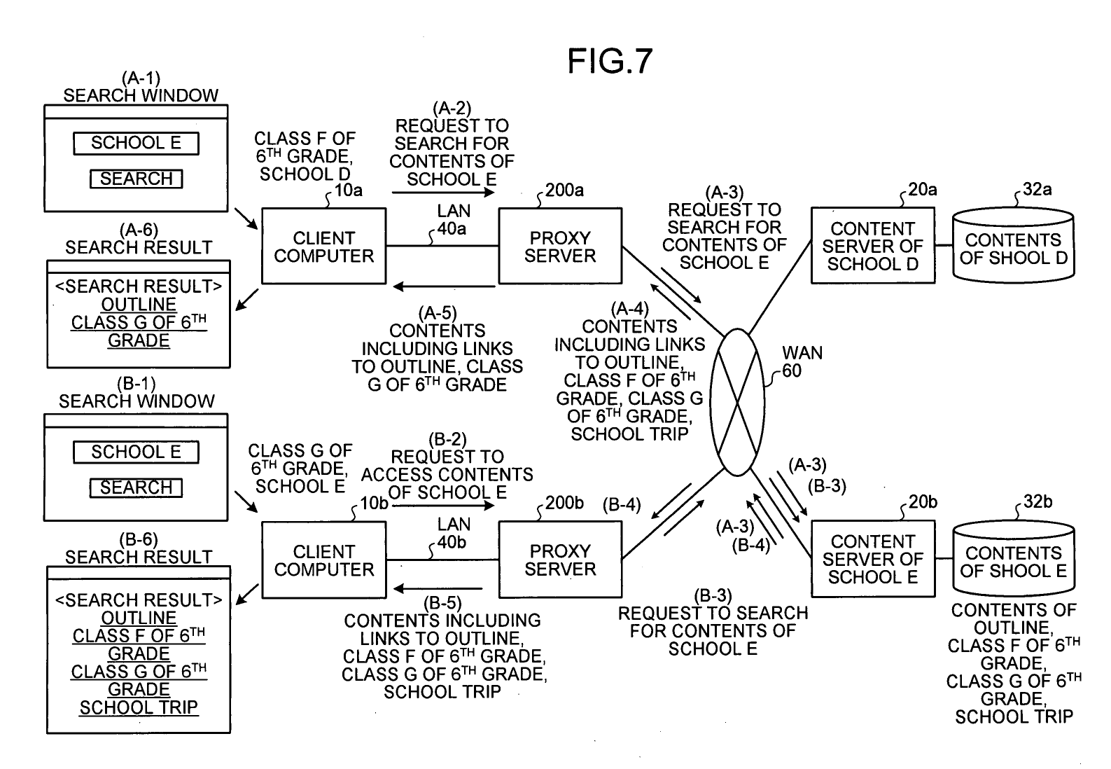

FIG. 7 is a schematic for explaining the concept of access restriction according to the second embodiment of the present invention. At a school D, a proxy server 200a is connected to a client computer 10a used by the class F of the sixth grade via a LAN 40a in the school. At a school E, a proxy server 200b is connected to a client computer 10b used by the class G of the sixth grade via a LAN 40b in the school.

The proxy server 200a and the proxy server 200b are connected via a WAN 60, and are further connected to a content server 20a of school D and a content server 20b of the school E via the WAN 60 respectively. The content server 20a manages the contents of the school D, and the content server 20b manages the contents of the school E.

Each of the proxy servers 200a and 200b stores therein an access prohibiting list that includes access-prohibited URLs; access-prohibiting information that associates each of the URLs with access-prohibited user information for identifying certain classes that are not permitted to access the URL; and access-permitted URLs for the contents indicated by the access-prohibited URLs, to which the users are exceptionally permitted to access. The URLs and information are generally registered by a network administrator at the school or the like in advance. It is assumed here that an internet protocol (IP) address assigned in advance to each of the client computers is used as the access-prohibited user information.

The proxy servers 200a and 200b restrict access from the classes to certain contents based on the access-prohibited URLs, the access-prohibiting information, and the access-permitted URLs in the access prohibiting list.

Each of the client computers 10a and 10b is installed with a browser for displaying contents. Using the browser, the class F of the sixth grade at the school D can view the contents of the schools D and E via the proxy server 200a, and the class G of the sixth grade at School E can also view the contents of the schools D and E via the proxy server 200b.

While a single client computer is used at each school in the explanation herein just for convenience, each of the proxy servers 200a and 200b can be actually connected to a plurality of client computers via the LAN 40a and 40b.

Such a system environment is used when collaborated classwork is conducted between the class F of the sixth grade at the school D and the class G of the sixth grade at the school E. In the collaborated classwork, students in the two classes at both schools communicate each other while referencing the contents created in each other's class.

It is assumed that, for example, the class F of the sixth grade at School D uses a specific search program executed on the client computer 10a to make a request to search for contents of School E (see (A-1) in FIG. 7). The client computer 10a then sends the request to the proxy server 200a with the content server 20b designated as the destination (see (A-2) in FIG. 7). The proxy server 200a transfers the request to the content server 20b (see (A-3) in FIG. 7).

Upon receiving the request, the content server 20b produces the contents of search result that includes the URL locating the contents of the school E, and sends the contents of the search result to the proxy server 200a.

For example, it is assumed that the content server 20b produces the search result contents that include the URLs locating contents named “outline”, “class F of the sixth grade”, “class G of the sixth grade”, and “school trip”, and sends the search result contents to the proxy server 200a (see (A-4) in FIG. 7).

After receiving the search result contents, the proxy server 200a analyzes the HTML information that defines the search result contents, and extracts the link URLs included in the search result contents. The proxy server 200a then checks whether there is a URL equivalent to any access-prohibited URL registered to the access prohibiting list among the extracted link URLs.

It is assumed here that, for example, the access prohibiting list includes a URL locating all the contents of the school E (such as a URL indicative of the uppermost directory when a directory configuration is used) as the access-prohibited URL, an IP address assigned to the client computer 10a as the access-prohibited user information, and URLs locating the contents of “outline” and “class G of the sixth grade” as the access-permitted URLs.

In this case, the class F of the sixth grade at the school D is permitted to access only the contents of “outline” and “class G of the sixth grade” among the contents of the school E.

The proxy server 200a deletes the link URLs to “class F of the sixth grade”, and “school trip” before sending the search result contents to the client computer 10a (see (A-5) in FIG. 7).

The client computer 10a displays the link information including only the link URLs to the contents of “outline” and “class G of the sixth grade” using the browser based on the search result contents (see (A-6) in FIG. 7).

On the other hand, it is assumed that the class G of the sixth grade at the school E also uses a specific search program executed on the client computer 10b to make a request to search for contents of the school E (see (B-1) in FIG. 7). The client computer 10b then sends the request to the proxy server 200b with the content server 20b designated as the destination (see (B-2) in FIG. 7). The proxy server 200b transfers the request to the content server 20b (see (B-3) in FIG. 7).

It is also assumed that the content server 20b produces the search result contents that include the URLs locating contents named “outline”, “class F of the sixth grade”, “class G of the sixth grade”, and “school trip”, and sends the search result contents to the proxy server 200b (see (B-4) in FIG. 7).

Assuming that the access prohibiting list in the proxy server 200b stores therein the same information as in the access prohibiting list in the proxy server 200a, the class G of sixth grade at the school E is permitted to access the full contents of the school E.

The proxy server 200b sends the search result contents to the client computer 10b as they were received from the content server 20b (see (B-5 in FIG. 7).

The client computer 10b displays the link information including the link URLs to the contents of “outline”, “class F of the sixth grade”, “class G of the sixth grade”, and “school trip” using the browser based on the search result contents (see (B-6) in FIG. 7).

In this manner, the proxy server 200a according to the second embodiment further stores therein the access-prohibited user information in association with the access-prohibited URLs, and checks whether the user identified by the access-prohibited user information is prohibited from accessing the contents located by the link URL included in the extracted link information. Because of this, the proxy server 200a can restrict access from a user to predetermined contents.

The proxy server 200a further stores therein the access-permitted URLs indicative of the access-prohibited URLs that are exceptionally permitted to access, and determines that the contents located by the link URL equivalent to one of the access-permitted URLs is permitted to access. This enables the proxy server 200a to perform access restriction flexibly by permitting access to certain contents among the access-prohibited contents as an exception.

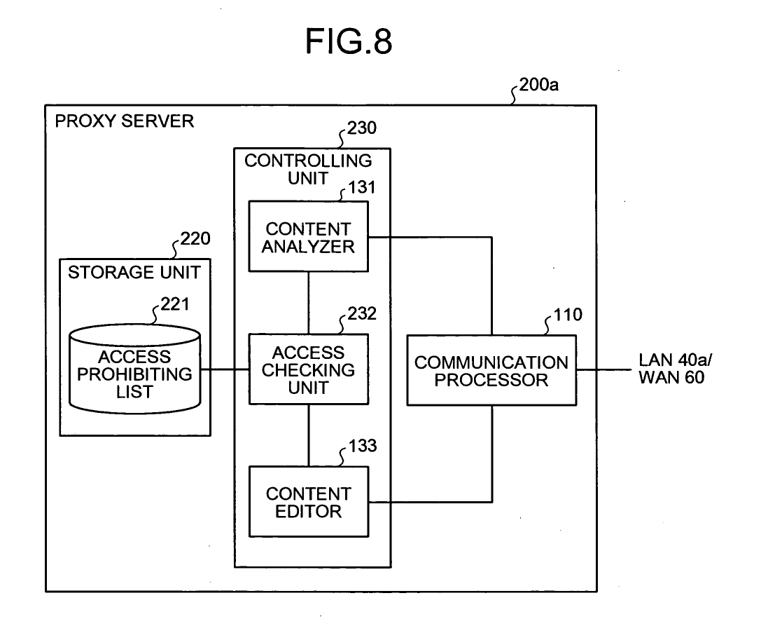

FIG. 8 is a detailed functional block diagram of the proxy server 200a. The proxy servers 200a and 200b shown in FIG. 7 have the identical configuration. Each of the units that function similarly to the units shown in FIG. 2 is denoted by the same reference numeral as in FIG. 2, and the explanation thereof is omitted here.

The proxy server 200a includes the communication processor 110, a storage unit 220, and a controlling unit 230.

The storage unit 220 stores therein data and computer programs required for various processes by the controlling unit 230. The storage unit 220 stores therein an access prohibiting list 221.

The access prohibiting list 221 includes access-prohibiting information used to determine whether access to certain contents is prohibited. More specifically, the access prohibiting list 221 includes the access-prohibiting information that associates the access-prohibited URLs specified by, for example, a network administrator in the school with the access-prohibited user information, and the access-permitted URLs. In the second embodiment, the access prohibiting list 221 uses IP addresses assigned to each client computer as the access-prohibited user information.

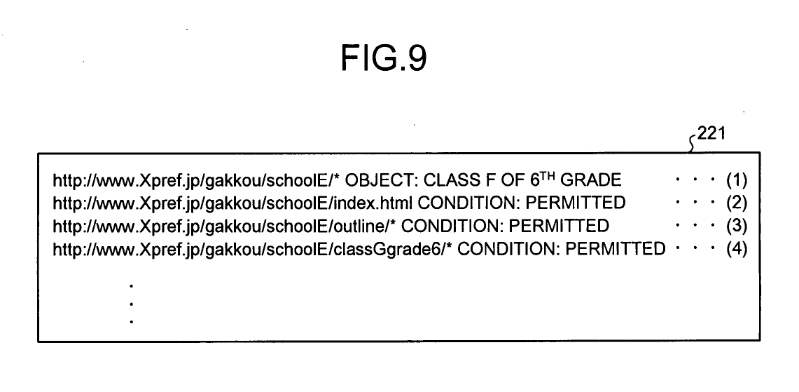

FIG. 9 is an example of the contents of the access prohibiting list 221. The access prohibiting list 221 includes, for example, the access-prohibiting information that associates the URL locating all the contents of the school E with the class F of the sixth grade that is prohibited to access the URL, as described by (1) in FIG. 9, and access-permitted URLs that the class F is exceptionally permitted to access, as described by (2), (3), and (4) in FIG. 9.

The asterisk used in each URL is a wildcard character that allows any character in the position. “OBJECT:” indicates that the preceding URL is an access-prohibited URL and that the following information is the access-prohibited user information. “CONDITION: PERMITTED” indicates that the preceding URL is the access-permitted URL. “CLASS F OF 6^{TH} GRADE”, or the access-prohibited user information, shown in (1) in FIG. 9 is expressed by an IP address assigned to the client computer 10a that is used in the class F of sixth grade at the school D.

The access prohibiting list 221 stores therein the access-prohibited URLs and the access-prohibited user information, whereby the proxy server 200a prohibits predetermined users from accessing predetermined access-prohibited contents.

The access prohibiting list 221 stores therein the access-prohibited URLs and the access-permitted URLs, whereby the proxy server 200a restricts access to predetermined access-prohibited contents.

The controlling unit 230 includes a memory to store therein a control program such as an OS, other computer programs that define various procedures, and required data, and the controlling unit 230 performs the procedures.

Specifically, the controlling unit 230 includes, as shown in FIG. 8, the content analyzer 131, an access checking unit 232, and the content editor 133.

The access checking unit 232 checks whether access to the contents located by the URL in the link information extracted by the content analyzer 131 is prohibited based on the access-prohibiting information in the access prohibiting list 221.

More specifically, the access checking unit 232 compares the URL in the link information extracted by the content analyzer 131 and the IP address of the client computer 10a in the access request with each of the access-prohibited URLs and the associated access-prohibited user information in the access prohibiting list 221.

If both of the access-prohibited URL and the access-prohibited user information match any one of the link URLs, the access checking unit 232 further compares the matched URL with the access-permitted URLs in the access prohibiting list 221.

If the access-permitted URL matches any one of the link URLs, the user is permitted to access the link URL. The access checking unit 232 removes the matched link URL from the access-prohibited link URLs, and transfers the link information including the remaining link URLs to the content editor 133 as the access-prohibited link information.

According to the second embodiment, the access prohibiting list 221 further stores therein the access-prohibited user information in association with the access-prohibited URLs; and the access checking unit 232 checks whether the user identified by the access-prohibited user information is permitted to access the contents located by the link URL in the link information extracted by the content analyzer 131 based on the access-prohibited URL. As a result, the configuration can restrict access to the contents based on the user.

According to the second embodiment, the access prohibiting list 221 further stores therein the access-permitted URL; and the access checking unit 232 determines that the contents located by the link URL equivalent to one of the access-permitted URLs is permitted to access. This permits the user to access certain contents as an exception among the access-prohibited contents, thus realizing flexible access restriction based on the contents of each URL.

While the access restriction is performed based on the user according to the second embodiment, the access restriction can be performed based on the status of the user.

According to a third embodiment, the access restriction is performed based on access-prohibited status that indicates the status of the user, in addition to the access-prohibited URL. The third embodiment is explained assuming that the proxy server is connected to a client computer via the LAN in a school and to a content server via the LAN in the school.

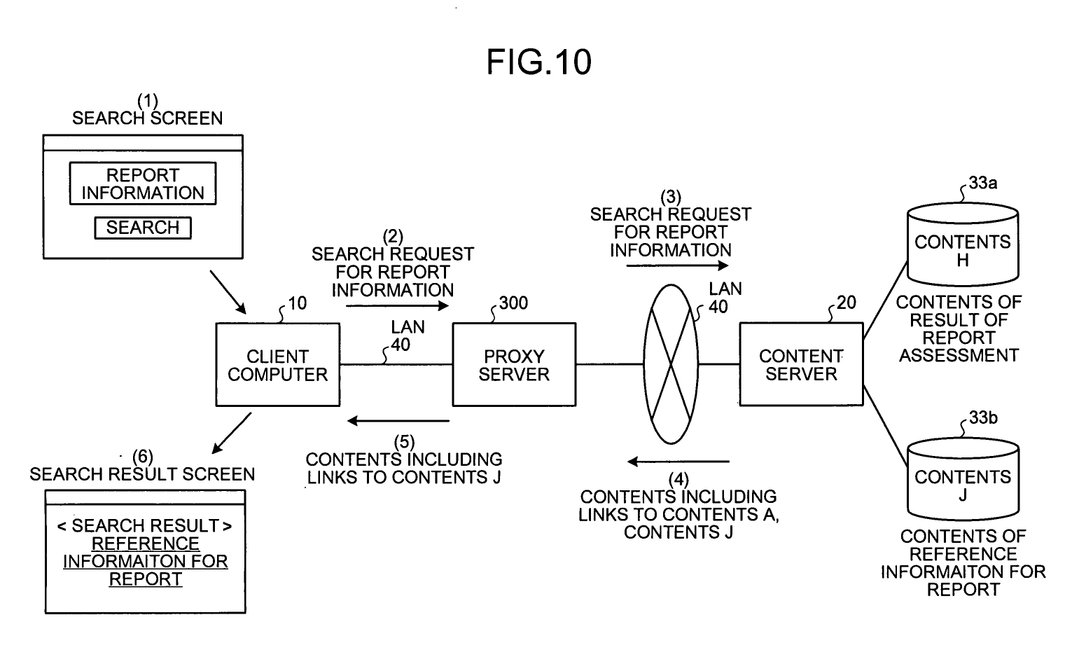

FIG. 10 is a schematic for explaining the concept of access restriction according to the third embodiment. A proxy server 300 is connected to the client computer 10 and the content server 20 via the LAN 40 in the school. The client computer 10 is used by the students of the school, and the content server 20 manages various contents including contents H 33a, contents J 33b, and other contents not shown in FIG. 10.

The proxy server 300 stores therein access-prohibiting information that associates the access-prohibited URLs with the access-prohibited status. The access-prohibiting information is generally registered by a network administrator at the school or the like in advance. The status herein indicates whether a student has submitted a report, whether the student achieved the target score in an examination, or the like. The access-prohibited status herein refers to the status in which the student is not permitted to access the contents, such that the report is not submitted, or the target score is not achieved.

The proxy server 300 restricts access from each student to various contents based on the access-prohibited URLs and information on the access-prohibited status in the access prohibiting list.

The client computer 10 includes a browser for displaying the contents. The student uses the browser to view various contents acquired through the proxy server 300, for example, to write a report.

While a single client computer 10 is used in the explanation below just for convenience, the proxy server 300 can be actually connected to a plurality of client computers via the LAN 40.

In such an environment, each of the students can collect information by browsing various contents managed by the content server 20 to write the report.

It is assumed here that a student who has not submitted the report uses a predetermined search engine executed on the client computer 10 to send a request for search for contents related to the report (see (1) in FIG. 10). A request for search in which the content server 20 is specified as the destination is sent from the client computer 10 to the proxy server 300 (see (2) in FIG. 10). Upon receiving the request for search, the proxy server 300 sends the request to the content server 20 (see (3) in FIG. 10).

The content server 20 then produces the contents of search result including the URLs indicative of the contents related to the report, and sends it to the proxy server 300.

For example, assuming the contents H 33a as the result of report assessment related to reports that have been submitted and the contents J 33b as the reference information for the report that helps writing the report, the content server 20 produces the search result contents including URLs locating the contents H 33a and the contents J 33b and sends the contents to the proxy server 300 as the contents related to the report information (see (4) in FIG. 10).

Upon receiving the search result contents, the proxy server 300 analyzes the HTML information that defines the search result contents, and extracts the link URLs included in the contents. The proxy server 300 then determines whether there is a URL equivalent to any access-prohibited URL registered to the access prohibiting list among the extracted link URLs.

It is assumed here that the access prohibiting list includes the link URL locating the contents H 33a as the access-prohibited URL, and the status that “the report is not submitted” as the access-prohibited status.

In this case, a student who has not yet submitted the report is prohibited from accessing the contents H 33a.

The proxy server 300 deletes the link URL to the contents H 33a from the search result contents, and sends the remaining contents to the client computer 10 (see (5) in FIG. 10).

The client computer 10 displays the link information including only the link URLs to the contents J 33b, namely the reference information for the report, via the browser based on the received search result contents (see (6) in FIG. 10).

In this manner, according to the third embodiment, the proxy server 300 further stores therein the access-prohibited status and checks whether the student is prohibited from accessing the requested contents based on the access-prohibited stats. As a result, access to the contents is restricted based on the status of the student.

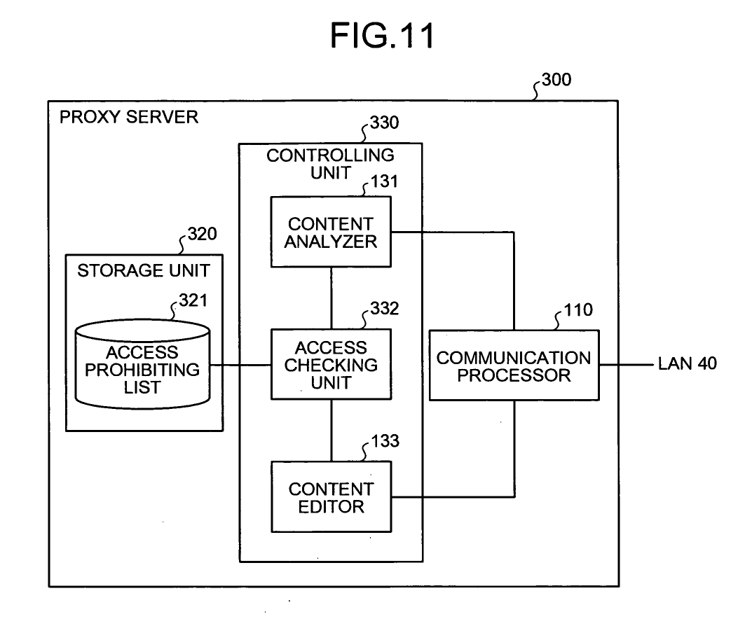

FIG. 11 is a detailed functional block diagram of the proxy server 300. Each of the units that function similarly to the units shown in FIG. 2 is denoted by the same reference numeral, and the explanation thereof is omitted here.

The proxy server 300 includes the communication processor 110, a storage unit 320, and a controlling unit 330.

The storage unit 320 stores therein data and programs required for processes performed by the controlling unit 330. The storage unit 320 includes an access prohibiting list 321.

The access prohibiting list 321 includes the access-prohibiting information used to determine whether access to the contents is prohibited. More specifically, the access prohibiting list 321 includes the access-prohibiting information that associates the access-prohibited URLs with the access-prohibited status.

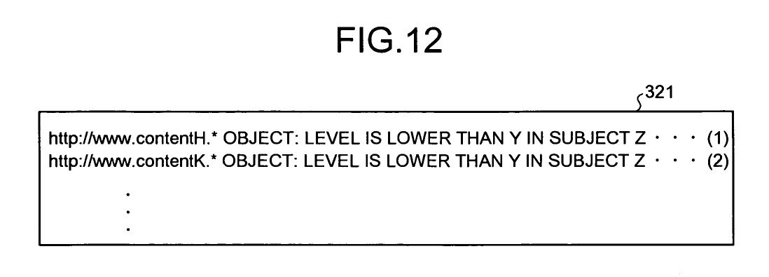

FIG. 12 is an example of the contents of the access prohibiting list 321. The access prohibiting list 321 includes, for example, access-prohibiting information that associates an access-prohibited URL locating the contents H with an access-prohibited status that the level is lower than Y in a subject Z, as described by (1) in FIG. 12; and access-prohibiting information that associates another access-prohibited URL locating the contents J with the access-prohibited status that the level is lower than Y in the subject Z, as described by (2) in FIG. 12.

The asterisk used in each URL is a wildcard character that allows any character in the position. “OBJECT:” indicates that the preceding URL is an access-prohibited URL and that the following information is the access-prohibited status. Assuming “Y” as the level of a student who has submitted the report in the subject “Z”, “LEVEL IS LOWER THAN Y IN SUBJECT Z” indicates the status of a student who has not submitted a report.

When the access prohibiting list 321 stores therein the access-prohibited URLs and the access-prohibited status for the access-prohibited URLs, the proxy server 300 can restrict the users in the predetermined status from accessing the predetermined access-prohibited contents.

The controlling unit 330 includes a memory to store therein a control program such as an OS, other computer programs that define various procedures, and required data, and the controlling unit 330 performs the procedures. Specifically, the controlling unit 330 includes, as shown in FIG. 8, the content analyzer 131, an access checking unit 332, and the content editor 133.

The access checking unit 332 checks whether access to the contents of the URL included in the link information extracted by the content analyzer 131 is prohibited based on the access-prohibiting information in the access prohibiting list 321.

More specifically, the access checking unit 332 compares the URL in the link information extracted by the content analyzer 131 and the status of the student who sent an access request with each of the access-prohibited URLs and the associated access-prohibited status in the access prohibiting list 221 to see if both of the access-prohibited URL and the access-prohibited status match any one of the link URLs.

The status of the student who sent the access request is acquired from information indicative of the status of each user, which is stored in the storage unit 220 by, for example, a status-managing unit that is not shown in FIG. 11. The student who sent the access request can be identified by a unique IP address when each student has his own client computer 10, or by a user identification (ID) stored in the cookie and the like, when each user has a unique user ID.

When both of the access-prohibited URL and the access-prohibited status match any one of the link URLs, the access checking unit 332 further transfers the link information that includes the URL to the content editor 133 as the access-prohibited link information.

According to the third embodiment, the access prohibiting list 321 further stores therein the access-prohibited status in association with the access-prohibited URL; and the access checking unit 332 checks whether the student in the access-prohibited status is prohibited from accessing the contents located by the link URL in the extracted link information based on the access-prohibited URLs. In this manner, access to the contents can be restricted based on the status of the user.

While the configurations of the proxy servers according to the first, the second, and the third embodiments were explained, an access restricting program including the identical functions can be also achieved by realizing the configuration of each proxy server on a software basis. The access restricting program is executed on a computer that operates as a proxy server.

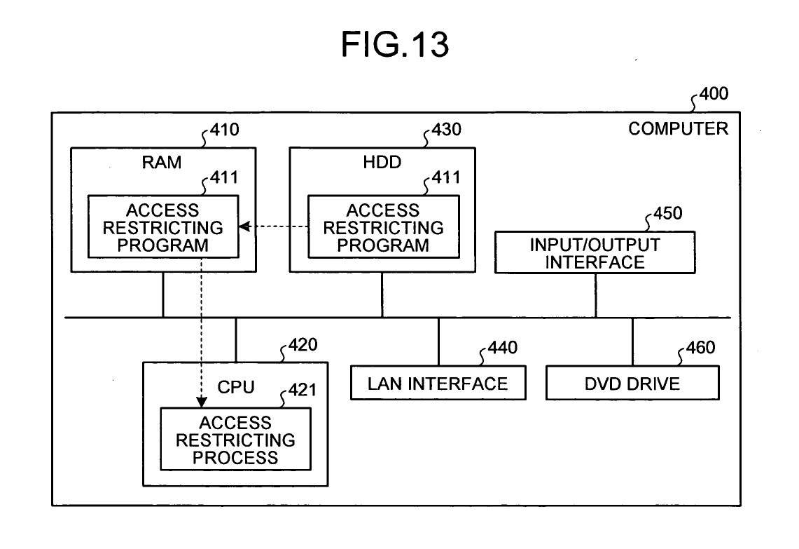

FIG. 13 is a functional block diagram of a computer 400 that implements steps, processes, methods etc. according to any one of the first, the second, and the third embodiments. The computer 400 includes a random access memory (RAM) 410, a central processing unit (CPU) 420, a hard disk drive (HDD) 430, a LAN interface 440, an input/output interface 450, and a digital versatile disk (DVD) drive 460.

The RAM 410 stores therein the program and the course of the program being executed. The CPU 420 reads and executes the program in the RAM 410.

The HDD 430 stores therein computer programs and data. The LAN interface 440 is used to connect the computer 400 to other computers via the LAN.

The input/output interface 450 is used to connect input units such as a mouse and a keyboard. The DVD drive 460 reads and writes data on a DVD.

An access restricting program 411 executed on the computer 400 is stored in the DVD, read by the DVD drive 460, and installed into the computer 400.

Otherwise, the access restricting program 411 can be stored in the database in another computer and the like connected to the computer 400 via the LAN interface 440, read from the database, and installed into the computer 400.

After the installation, the access restricting program 411 is stored in the HDD 430, read by the RAM 410 so that an access-restricting process 421 is executed by the CUP 420. The access-restricting process 421 is the process of restricting access to certain contents.

A configuration according to an aspect of the present invention can provide only the link information indicative of the contents permitted to access to the users. This is advantageous in that the user can efficiently collect information without wasting time by trying to access prohibited websites.

A configuration according to another aspect can provide only the link addresses locating the contents permitted to access to the users. This is advantageous in that the user can efficiently collect information without wasting time by trying to access prohibited websites.

A configuration according to still another aspect can restrict access to certain contents based on the user who requests to access the contents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that enables a proxy server to control access from a client computer to contents in a contents server, the computer program causing the proxy server to execute:
receiving an access request from the client computer indicative of permission to access first contents in the contents server and sending received access request to the contents server;
analyzing the first contents received from the content server in response to the access request;
extracting link information included in the first contents that is linked to second contents;
checking whether access to the second contents has been prohibited based on access-prohibiting information;
deleting the link information of the second contents from the first contents if it is determined at the checking that access has been prohibited to the second contents thereby obtaining third contents; and
sending the third contents to the client computer.

2. The computer-readable recording medium according to claim 1, wherein
access-prohibiting information includes access-prohibited addresses.

3. The computer-readable recording medium according to claim 2, wherein
access-prohibiting information includes access-prohibited user information used to identify a user who is prohibited to access the first contents located by the access-prohibited address in association with the access-prohibited address.

4. The computer-readable recording medium according to claim 2, wherein
the checking includes checking whether access to the second contents has been prohibited based on a condition, and determining that access to the second contents is not to be prohibited when the condition is fulfilled.

5. The computer-readable recording medium according to claim 2, wherein
the checking includes checking whether access to the second contents has been prohibited based on information about status of user of the client terminal.

6. The computer-readable recording medium according to claim 1, wherein access-prohibiting information includes a character string.

7. The computer-readable recording medium according to claim 1, further comprising creating, when the link information of the second contents is deleted at the deleting from the first contents, deletion information indicative of the fact that the link information of the second contents is deleted at the deleting from the first contents, and
the sending includes sending the deletion information along with the third contents to the client computer.

8. The computer-readable recording medium according to claim 1, wherein the deleting includes deleting a paragraph that includes the link information of the second contents.

9. A method executed by a proxy server to control access from a client computer to contents in a contents server, the method comprising:
receiving an access request from the client computer indicative of permission to access first contents in the contents server and sending received access request to the contents server;
analyzing the first contents received from the content server in response to the access request;
extracting link information included in the first contents that is linked to second contents;
checking whether access to the second contents has been prohibited based on access-prohibiting information;
deleting the link information of the second contents from the first contents if it is determined at the checking that access has been prohibited to the second contents thereby obtaining third contents; and
sending the third contents to the client computer.

10. A proxy server that controls access from a client computer to contents in a contents server, the proxy server comprising:
a storage unit that stores therein access-prohibiting information;
a communication unit that receives an access request from the client computer indicative of permission to access first contents in the contents server and sends received access request to the contents server;
a contents extracting unit that analyzes the first contents received from the content server in response to the access request, and extracts link information included in the first contents that is linked to second contents;
an access checking unit that checks whether access to the second contents has been prohibited based on the access-prohibiting information; and
a contents deleting unit that deletes the link information of the second contents from the first contents if it is determined at the checking that access has been prohibited to the second contents thereby obtaining third contents, wherein
the communication unit sends the third contents to the client computer.
